(19) United States
(12) Patent Application Publication
(10) Pub. No.: US 2016/0259774 A1
(43) Pub. Date: Sep. 8, 2016

(54) INFORMATION PROCESSING APPARATUS, INFORMATION PROCESSING METHOD, AND NON-TRANSITORY COMPUTER READABLE MEDIUM

(71) Applicant: FUJI XEROX Co., Ltd., Tokyo (JP)

(72) Inventors: Yasuhide MIURA, Kanagawa (JP); Shigeyuki SAKAKI, Kanagawa (JP); Tomoko OKUMA, Kanagawa (JP)

(73) Assignee: FUJI XEROX Co., Ltd., Tokyo (JP)

(21) Appl. No.: 14/829,804

(22) Filed: Aug. 19, 2015

(30) Foreign Application Priority Data
Mar. 2, 2015 (JP) 2015-039955

(51) Int. Cl. G06F 17/27

(52) U.S. Cl. CPC G06F 17/2705

(57) ABSTRACT

An information processing apparatus includes a first extracting unit, a second extracting unit, and a third extracting unit. The first extracting unit applies a topic model to target text information and extracts topic distributions for words constituting the text information. The second extracting unit extracts a first topic for the text information from the topic distributions extracted by the first extracting unit. The third extracting unit extracts a word satisfying a predetermined condition, from at least one word having the first topic, as a context word in the text information. The first topic is extracted by the second extracting unit.

### CROSS-REFERENCE TO RELATED APPLICATIONS

This application is based on and claims priority under 35 USC 119 from Japanese Patent Application No. 2015-039955 filed Mar. 2, 2015.

### BACKGROUND

### Technical Field

The present invention relates to an information processing apparatus, an information processing method, and a non-transitory computer readable medium.

### SUMMARY

The gist of the present invention resides in an aspect of the present invention as described below.

According to an aspect of the invention, there is provided an information processing apparatus including a first extracting unit, a second extracting unit, and a third extracting unit. The first extracting unit applies a topic model to target text information and extracts topic distributions for words constituting the text information. The second extracting unit extracts a first topic for the text information from the topic distributions extracted by the first extracting unit. The third extracting unit extracts a word satisfying a predetermined condition, from at least one word having the first topic, as a context word in the text information. The first topic is extracted by the second extracting unit.

### BRIEF DESCRIPTION OF THE DRAWINGS

Exemplary embodiments of the present invention will be described in detail based on the following figures, wherein:

FIG. 1 is a conceptual diagram illustrating an exemplary module configuration according to a first exemplary embodiment;

FIG. 2 is a diagram for describing an exemplary system configuration using the first exemplary embodiment;

FIG. 3 is a flowchart of an exemplary process according to the first exemplary embodiment;

FIG. 4 is a diagram for describing an exemplary data structure of a document table;

FIG. 5 is a flowchart of an exemplary process according the first exemplary embodiment;

FIG. 6 is a diagram for describing an exemplary process according to the first exemplary embodiment;

FIG. 7 is a conceptual diagram illustrating an exemplary module configuration according to a second exemplary embodiment;

FIG. 8 is a flowchart of an exemplary process according to the second exemplary embodiment;

FIG. 9 is a diagram for describing an exemplary data structure of a topic-distribution table;

FIG. 10 is a diagram for describing an exemplary process according to the second exemplary embodiment;

FIG. 11 is a conceptual diagram illustrating an exemplary module configuration according to a third exemplary embodiment;

FIG. 12 is a flowchart of an exemplary process according to the third exemplary embodiment;

FIG. 13 is a diagram for describing an exemplary data structure of a document table;

FIG. 14 is a conceptual diagram illustrating an exemplary module configuration according to a fourth exemplary embodiment; and

FIG. 15 is a block diagram illustrating an exemplary hardware configuration of a computer for achieving the exemplary embodiments.

### DETAILED DESCRIPTION

Various exemplary embodiments suitable to embody the present invention will be described below on the basis of the drawings.

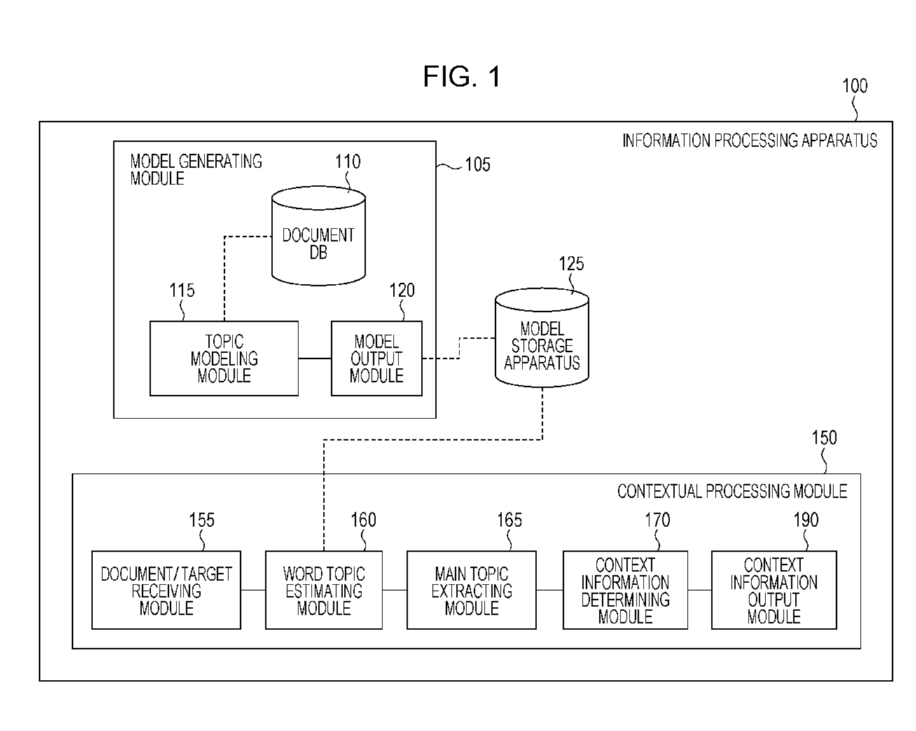

FIG. 1 is a conceptual diagram illustrating an exemplary module configuration according to a first exemplary embodiment.

In general, a module refers to a component, such as software (a computer program) that is logically separable or hardware. Thus, a module in the exemplary embodiment refers to not only a module in terms of a computer program but also a module in terms of a hardware configuration. Consequently, the description of the exemplary embodiment also serves as a description of a system, a method, and a computer program which cause the hardware configuration to function as a module (a program that causes a computer to execute procedures, a program that causes a computer to function as units, or a program that causes a computer to implement functions). For convenience of explanation, the terms “to store something” and “to cause something to store something”, and equivalent terms are used. These terms mean that a storage apparatus stores something or that a storage apparatus is controlled so as to store something, when the exemplary embodiment is achieved by using computer programs. One module may correspond to one function. However, in the implementation, one program may constitute one module, or one program may constitute multiple modules. Alternatively, multiple programs may constitute one module. Additionally, multiple modules may be executed by one computer, or one module may be executed by multiple computers in a distributed or parallel processing environment. One module may include another module. Hereinafter, the term “connect” refers to logical connection, such as transmission/reception of data, an instruction, or reference relationship between pieces of data, as well as physical connection. The term “predetermined” refers to a state in which determination has been made before a target process. This term also includes a meaning in which determination has been made in accordance with the situation or the state at that time or the situation or the state before that time, not only before processes according to the exemplary embodiment start, but also before the target process starts even after the processes according to the exemplary embodiment have started. When multiple “predetermined values” are present, these may be different from each other, or two or more of the values (including all values, of course) may be the same. A description having a meaning of “when A is satisfied, B is performed” is used as having a meaning of “whether or not A is satisfied is determined and, when it is determined that A is satisfied, B is performed”. However, this term does not include a case where the determination of whether or not A is satisfied is unnecessary.

A system or an apparatus refers to one in which multiple computers, pieces of hardware, devices, and the like are connected to each other by using a communication unit such as a network which includes one-to-one communication connection, and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (social system) operating on man-made agreements.

In each of the processes performed by modules, or in each of the processes performed in a module, target information is read out from a storage apparatus. After the process is performed, the processing result is written in a storage apparatus. Accordingly, no description about the reading of data from the storage apparatus before the process and the writing into the storage apparatus after the process may be made. Examples of the storage apparatus may include a hard disk, a random access memory (RAM), an external storage medium, a storage apparatus via a communication line, and a register in a central processing unit (CPU).

An information processing apparatus 100 according to the first exemplary embodiment extracts context words for the first topic (may be hereinafter referred to as the main topic) for target text information. As illustrated in the example in FIG. 1, the information processing apparatus 100 includes a model generating module 105, a model storage apparatus 125, and a contextual processing module 150. Specifically, the information processing apparatus 100 uses a topic model to extract the main topic for a target, and obtains context information for the target on the basis of the main topic. Examples of text information (may be hereinafter referred to as text) include sentence data (including one sentence and multiple sentences), a writing, and a document.

Terms used in the description in the exemplary embodiment will be described below.

The term “polarity” means a property of a document or a word based on a certain pole. In the description in the exemplary embodiment, “polarity” indicates a property of the positive sensibility pole or the negative sensibility pole.

The term “target” means a target for which context information is to be extracted. Examples of a target include a person name, an organization name, a place name, and a product name.

The term “topic” means a multinomial word distribution which is output by using a topic modeling technique, such as latent Dirichlet allocation (LDA) or Labeled LDA. In a topic, a word having stronger relationship has a higher probability value. A term “cluster”, “latent class”, or the like may be also used as an alias of the term “topic”.

The term “model” means data obtained as a learning result using a machine learning technique. In the description in the exemplary embodiment, it indicates a learning result using a topic modeling technique. For example, a resulting model obtained by subjecting a text set to learning using a topic modeling technique may be used to estimate a topic distribution for a word.

The term “supervised signal” means data showing a correct result produced for certain input data on the basis of some criterion. For example, a supervised signal may be used as data representing a correct classification result for a certain input data example in a learning process. Learning using a combination of such input data and a supervised signal which is the classification result enables a model to be generated.

In a determination process, use of a model, which is obtained by performing machine learning, on input data whose classification is not known enables classification of the input data to be presumed. Thus, a supervised signal may indicate correct output result data which is determined on the basis of a certain criterion and which is produced for input data.

In techniques of the related art, syntax information is used to obtain context information for a target. In a technique using syntax information, when text (for example, colloquial words such as social media text, words which are used by young people and which include new words, and a sentence having a grammatical error) which has plenty of noise which causes accuracy of syntactic analysis to be decreased is a target, the performance is decreased due to an error in syntactic analysis.

The model generating module 105 includes a document database (DB) 110, a topic modeling module 115, and a model output module 120. The model generating module 105 applies a topic modeling technique to a text set, and generates a topic model. Examples of a text set include a writing posted in a social networking service (SNS), such as a tweet.

The contextual processing module 150 includes a document/target receiving module 155, a word topic estimating module 160, a main topic extracting module 165, a context information determining module 170, and a context information output module 190. The contextual processing module 150 applies the topic model generated by the model generating module 105, to text to be analyzed, and obtains a topic distribution for each word. The contextual processing module 150 extracts a topic, for example, having the highest probability, as the main topic on the basis of the topic distributions for the target. Then, the contextual processing module 150 extracts, for example, words whose highest probability is one for the main topic, among words other than the target, as context information for the target.

The document DB 110 is connected to the topic modeling module 115. The document DB 110 is used to store text collected in advance. For example, text collected from an SNS is stored.

The topic modeling module 115 is connected to the document DB 110 and the model output module 120. From multiple texts stored in the document DB 110, the topic modeling module 115 extracts words constituting the texts. The topic modeling module 115 applies the topic modeling technique to the extracted words, and generates a topic model. The topic modeling module 115 transmits the generated topic model to the model output module 120.

The model output module 120 is connected to the topic modeling module 115 and the model storage apparatus 125. The model output module 120 stores the topic model generated by the topic modeling module 115, in the model storage apparatus 125.

The model storage apparatus 125 is connected to the model output module 120 and the word topic estimating module 160. The model storage apparatus 125 stores the topic model which is output from the model output module 120 (the topic model generated by topic modeling module 115). The model storage apparatus 125 supplies the topic model to the word topic estimating module 160 of the contextual processing module 150.

The document/target receiving module 155 is connected to the word topic estimating module 160. The document/target receiving module 155 receives a target and a target text. The target text is a text which is a target from which context words for the topic are extracted. For example, the target text may be a text created through a user operation using a mouse, a keyboard, a touch panel, voice, a line of sight, a gesture, or the like, or may be a text obtained by reading out a text stored in a storage apparatus such as a hard disk (including a storage apparatus included in a computer, and a storage apparatus connected via a network) or the like.

The word topic estimating module 160 is connected to the model storage apparatus 125, the document/target receiving module 155, and the main topic extracting module 165. The word topic estimating module 160 applies the topic model to the target text, and extracts topic distributions for the words constituting the text. The expression “words constituting text information” means words included in the text information. The term “topic distribution” means a probability of a topic indicated by a target word. In the case where it is possible to attach multiple topics to one word, the term “topic distribution” means probabilities of the topics. For example, as described below, for the word “ [symbol] ” which means “Food A”, a probability that the topic indicated by the word is “T1” is 100%. For the word “ [symbol] ” which means “selling”, topics indicated by the word are “T1” and “T2”. A probability that the topic indicated by the word is “T1” is 66.7%, and a probability that the topic indicated by the word is “T2” is 33.3%. That is, in the specific data structure of a topic distribution, a word may correspond to one or more sets (pairs) of a topic indicated by the word and a probability value for the topic.

The main topic extracting module 165 is connected to the word topic estimating module 160 and the context information determining module 170. The main topic extracting module 165 extracts the main topic for the target text from the topic distributions extracted by the word topic estimating module 160. Specifically, the main topic extracting module 165 extracts the topic having the highest probability value, from the topic distributions as the main topic for the target.

The context information determining module 170 is connected to the main topic extracting module 165 and the context information output module 190. The context information determining module 170 extracts a word satisfying a predetermined condition, from words having the main topic extracted by the main topic extracting module 165, as a context word in the text. The “predetermined condition” may be, for example, (1) a condition that, when the topic having the highest probability value among the topics for a word is the main topic, the word is regarded as a context word, (2) a condition that, when a topic having a probability value equal to or higher than a predetermined threshold, among the topics for a word is the main topic, the word is regarded as a context word, or (3) a condition that, when the topic having the highest probability value equal to or higher than a predetermined threshold, among the topics for a word is the main topic, the word is regarded as a context word. Multiple words may be extracted as context words.

The context information output module 190 is connected to the context information determining module 170. The context information output module 190 receives the context word (word set) extracted by the context information determining module 170, and outputs the context word. Examples of the outputting the context word include printing the context word using a printer apparatus such as a printer, displaying the context word on a display apparatus such as a display, writing the context word into a storage apparatus such as a database, storing the context word into a storage medium such as a memory card, and transmitting the context word to another information processing apparatus. As information to be output, not only the context word but also a correspondence between the target text and the context word may be output.

The post-processing of the information processing apparatus 100 is, for example, as follows. The information processing apparatus 100 extracts words for the main topic from each sentence in an SNS in which evaluation texts for a certain product which is a target are written, receives information which is output by the context information output module 190, determines the polarity of each word for the main topic, and determines whether the product is evaluated as being positive (affirmative) or negative (critical).

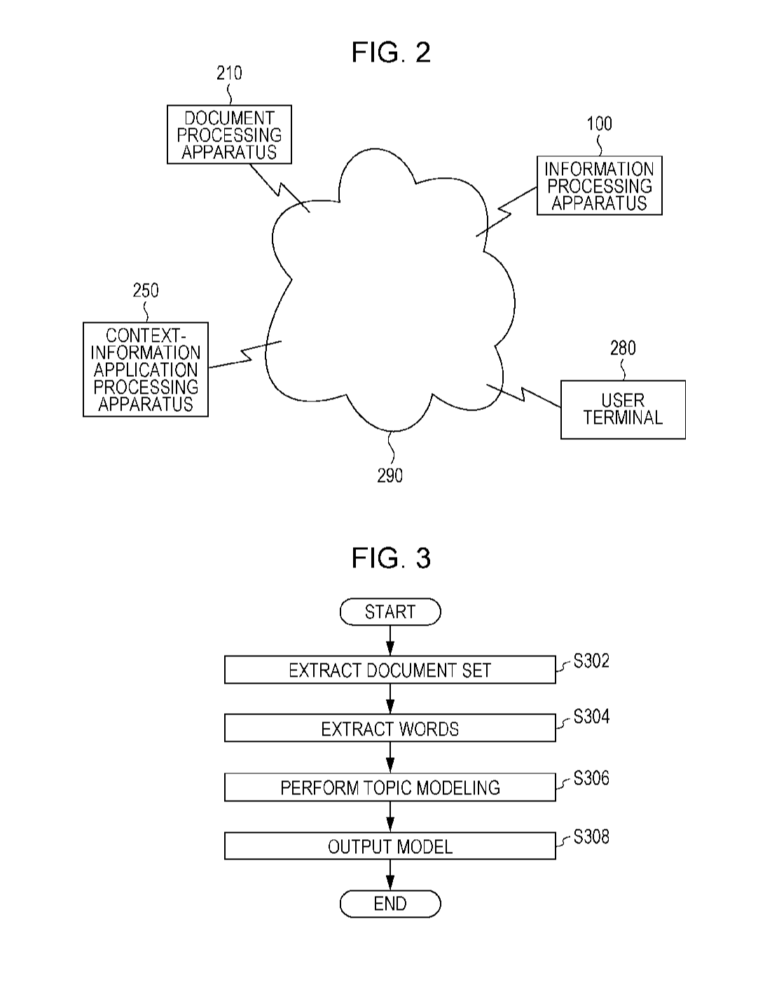

FIG. 2 is a diagram for describing an exemplary system configuration using the first exemplary embodiment.

The information processing apparatus 100, a document processing apparatus 210, a context-information application processing apparatus 250, and a user terminal 280 are connected with one another via a communication line 290. The communication line 290 may be wireless, wired, or may be a combination of these. For example, the communication line 290 may be, for example, the Internet or an intranet which serves as a communication infrastructure. The document processing apparatus 210 provides a service such as an SNS, and collects texts. Instead, the document processing apparatus 210 collects texts from an information processing apparatus providing a service such as an SNS. The information processing apparatus 100 extracts context information by using the texts collected by the document processing apparatus 210. The context-information application processing apparatus 250 performs processing using the context information. The user terminal 280 receives processing results produced by the information processing apparatus 100 and the context-information application processing apparatus 250, and presents them to a user. The functions of the information processing apparatus 100, the document processing apparatus 210, and the context-information application processing apparatus 250 may be implemented as cloud services. The document processing apparatus 210 may include the model generating module 105 and the model storage apparatus 125. In this case, the information processing apparatus 100 receives a topic model from the document processing apparatus 210. The user terminal 280 may be a portable terminal.

FIG. 3 is a flowchart of an exemplary process performed in the first exemplary embodiment (by the model generating module 105).

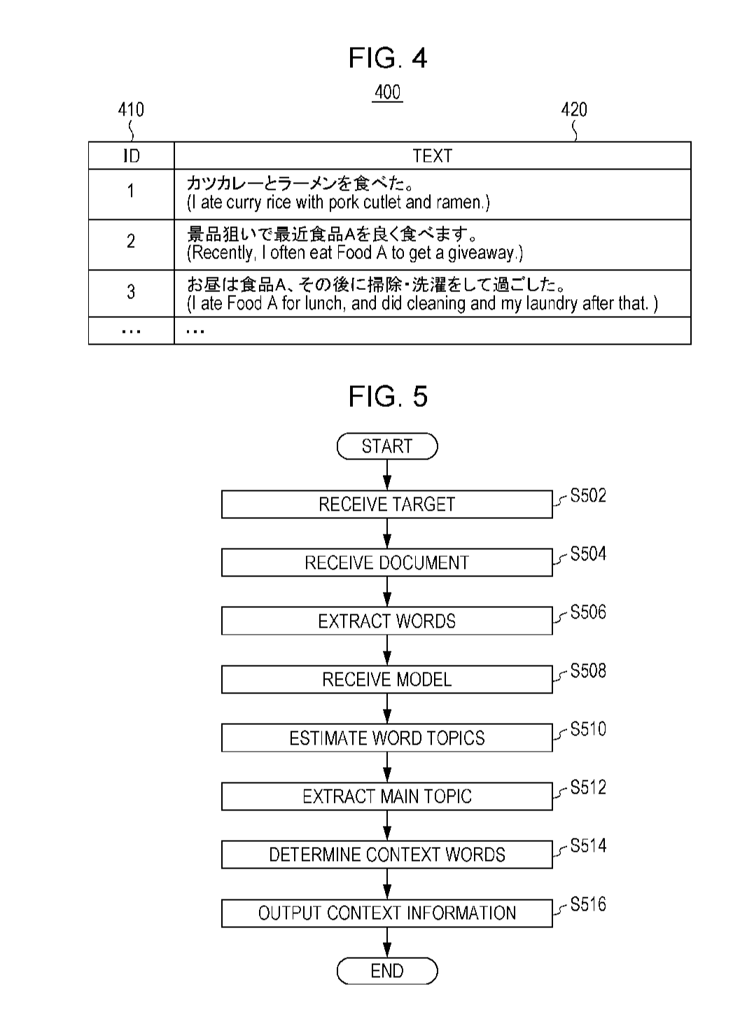

In step S302, the topic modeling module 115 extracts a document set. The topic modeling module 115 extracts a document set from the document DB 110. In the document DB 110, for example, a document table 400 is stored. FIG. 4 is a diagram for describing an exemplary data structure of the document table 400. The document table 400 includes an ID column 410 and a text column 420. In the ID column 410, information (ID: identification) for identifying a text in the text column 420 uniquely is stored in the exemplary embodiment. In the text column 420, a text is stored. In FIG. 4, a text stored in the text column 420 includes one sentence, but may include multiple sentences. It is assumed that thousands to millions of documents are present in a document set. The more, the better, as long as a computer may handle the documents.

In step S304, the topic modeling module 115 extracts words. The topic modeling module 115 extracts words from each text. In extraction of words, a part of speech (POS) tagger or the like is used when the text is English, and a morphological analyzer or the like is used when the text is Japanese.

In step S306, the topic modeling module 115 performs topic modeling. The topic modeling module 115 applies the topic modeling technique to the word set for each text. Specifically, a technique such as latent Dirichlet allocation (LDA) is used.

In step S308, the model output module 120 outputs a topic model. The model output module 120 outputs the generated topic model.

FIG. 5 is a flowchart of an exemplary process performed in the first exemplary embodiment (by the contextual processing module 150).

In step S502, the document/target receiving module 155 receives a target. The document/target receiving module 155 receives input of a target for which context information is to be extracted. For example, “ [symbol] ” (“Food A”) is received.

In step S504, the document/target receiving module 155 receives a document which is text. The document/target receiving module 155 receives input of a text from which context information for the target is to be extracted. For example, a text “ [symbol] [symbol] [symbol] [symbol] [symbol] ” which means “Food A of Flavor B is selling very well, and is already in short supply. Our store has it in stock.” is received.

In step S506, the word topic estimating module 160 extracts words from the text. For example, in the above-described example, the extraction result is “ [symbol] [symbol] [symbol] [symbol] [symbol] ”. The symbol “/” indicates a separator of a word.

In step S508, the word topic estimating module 160 receives a model. That is, the word topic estimating module 160 reads the topic model generated according to the flowchart illustrated in the example in FIG. 3.

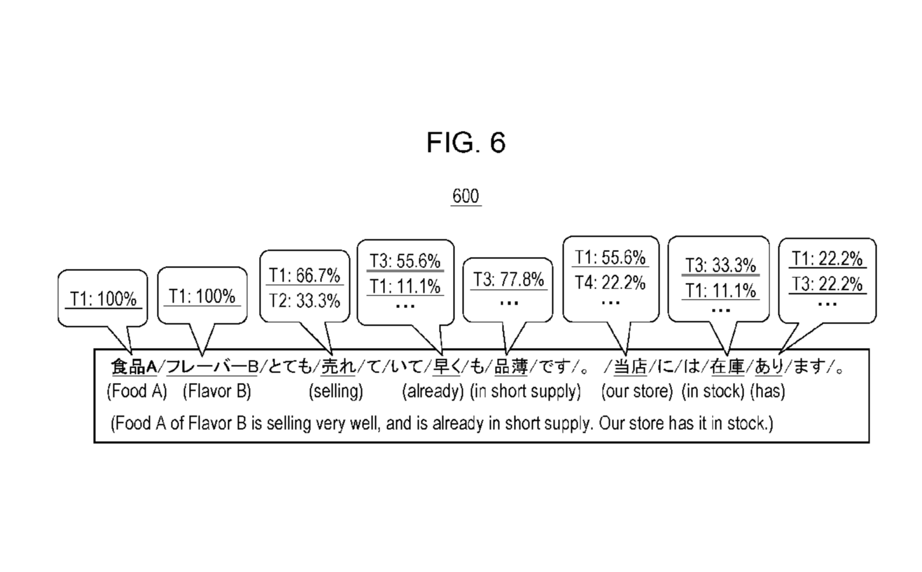

In step S510, the word topic estimating module 160 estimates word topics. That is, the word topic estimating module 160 estimates a topic for each word by using the topic modeling technique. FIG. 6 is a diagram for describing an exemplary process in step S510. In FIG. 6, T means a topic, and, for example, T1 represents Topic 1.

A word extraction result 600 shows “ [symbol] [symbol] [symbol] [symbol] [symbol] ”.

As a result of the process performed by the word topic estimating module 160, topic distributions are estimated as follows: “100% for Topic 1” for “ [symbol] ” (“Food A”); “100% for Topic 1” for “ [symbol] ” (“Flavor B”); “66.7% for Topic 1 and 33.3% for Topic 2” for “ [symbol] ” (“selling”); “55.6% for Topic 3 and 11.1% for Topic 1” for “ [symbol] ” (“already”); “77.8% for Topic 3” for “ [symbol] ” (“in short supply”); “55.6% for Topic 1 and 22.2% for Topic 4” for “ [symbol] ” (“our store”); “33.3% for Topic 3 and 11.1% for Topic 1” for “ [symbol] ” (“in stock”); and “22.2% for Topic 1 and 22.2% for Topic 3” for “ [symbol] ” (“has”).

In step S512, the main topic extracting module 165 extracts the main topic. Specifically, the main topic extracting module 165 extracts a topic having the highest probability value among the topics for a word corresponding to the target, as the main topic. In the above-described example, the target is “ [symbol] ” (“Food A”). Since the topic distribution of “ [symbol] ” is “100% for Topic 1”, Topic 1 is extracted as the main topic.

In step S514, the context information determining module 170 determines context words. The context information determining module 170 determines a word whose highest probability value is one for the main topic (Topic 1), to be a context word. In the example illustrated in FIG. 6, words “ [symbol] [symbol] ” (words with a single underline in FIG. 6) which mean “Food A/Flavor B/selling/our store/has” are determined to be context words. Alternatively, instead of use of the highest probability value, a word having a probability value equal to or higher than a predetermined threshold may be determined to be a context word.

In step S516, the context information output module 190 outputs the context information for the target. In the above-described example, the words “ [symbol] [symbol] ” are output.

### Second Exemplary Embodiment

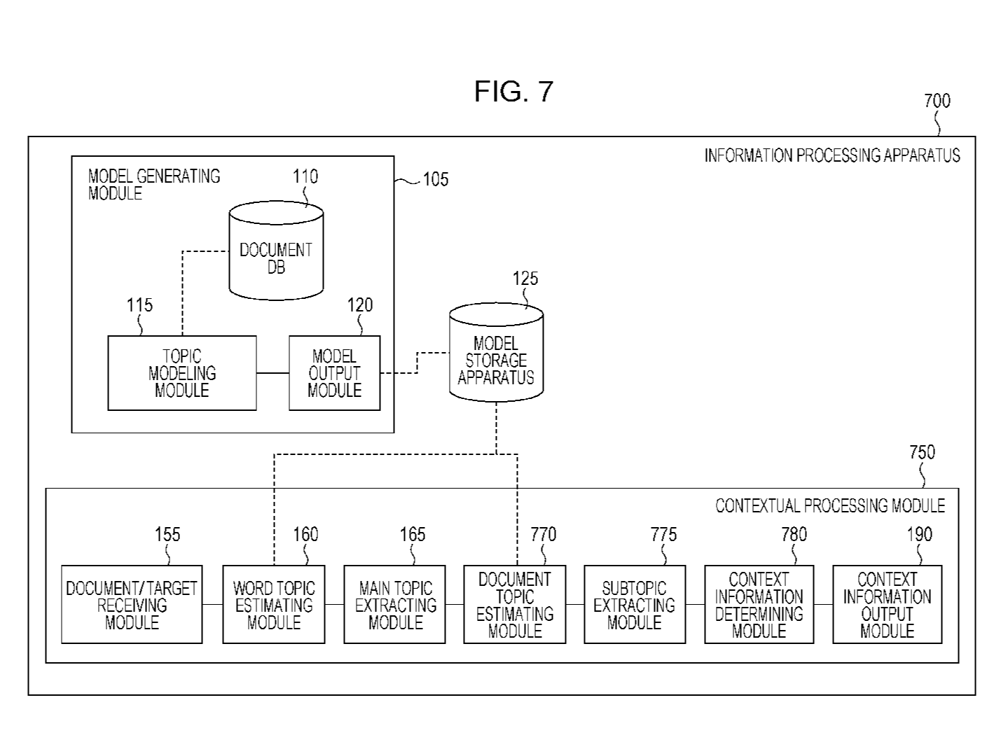

FIG. 7 is a conceptual diagram illustrating an exemplary module configuration according to a second exemplary embodiment. The second exemplary embodiment is one obtained by substituting a document topic estimating module 770, a subtopic extracting module 775, and a context information determining module 780 for the context information determining module 170 of the information processing apparatus 100 according to the first exemplary embodiment. By extracting a subtopic for a target on the basis of topics, context information for the target which covers a range wider than that in the first exemplary embodiment may be obtained.

An information processing apparatus 700 includes the model generating module 105, the model storage apparatus 125, and a contextual processing module 750. The contextual processing module 750 includes the document/target receiving module 155, the word topic estimating module 160, the main topic extracting module 165, the document topic estimating module 770, the subtopic extracting module 775, the context information determining module 780, and the context information output module 190. Components similar to those in the first exemplary embodiment are designated with identical reference numerals, and repeated description will be avoided.

The model storage apparatus 125 is connected to the model output module 120, the word topic estimating module 160, and the document topic estimating module 770.

The main topic extracting module 165 is connected to the word topic estimating module 160 and the document topic estimating module 770.

The document topic estimating module 770 is connected to the model storage apparatus 125, the main topic extracting module 165, and the subtopic extracting module 775. The document topic estimating module 770 applies the topic modeling technique to the target text, and extracts topic distributions in the text.

The subtopic extracting module 775 is connected to the document topic estimating module 770 and the context information determining module 780. The subtopic extracting module 775 extracts a second topic (may be hereinafter referred to as a subtopic) for the text from the topic distributions extracted by the document topic estimating module 770. That is, in consideration of a subtopic for the target, context information covering a wider range may be extracted.

The context information determining module 780 is connected to the subtopic extracting module 775 and the context information output module 190. The context information determining module 780 extracts a word satisfying a predetermined condition among words having the subtopic extracted by the subtopic extracting module 775, as a context word. Further, the process performed by the context information determining module 170 in the first exemplary embodiment may be performed.

The context information output module 190 is connected to the context information determining module 780.

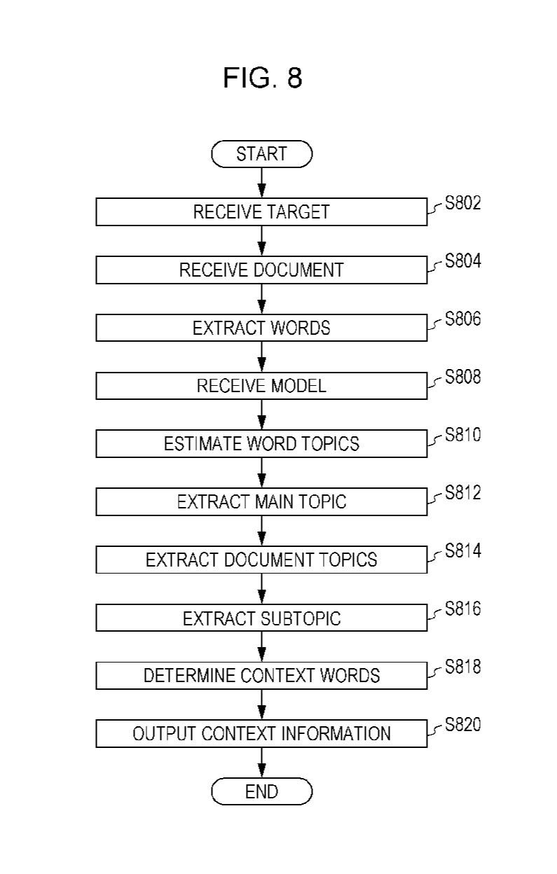

FIG. 8 is a flowchart of an exemplary process according to the second exemplary embodiment. The processes in steps S802 to S812 are equivalent to those in steps S502 to S512 in the flowchart illustrated in the example in FIG. 5.

In step S802, the document/target receiving module 155 receives a target.

In step S804, the document/target receiving module 155 receives a document.

In step S806, the word topic estimating module 160 extracts words.

In step S808, the word topic estimating module 160 receives the model.

In step S810, the word topic estimating module 160 estimates word topics.

In step S812, the main topic extracting module 165 extracts the main topic.

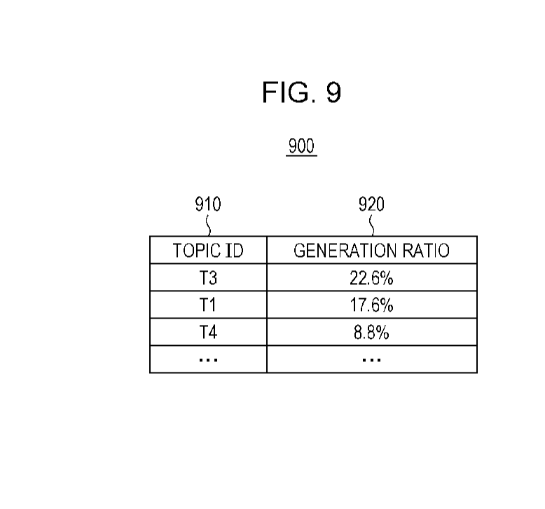

In step S814, the document topic estimating module 770 extracts document topics. The document topic estimating module 770 estimates topics for the document by using the topic modeling technique. A document topic is obtained by normalizing the sum of the topic distributions for the words. In the normalization, for example, the sum of the topic distributions may be divided by the number of words (or the number of words used in the addition). An example is a topic-distribution table 900. FIG. 9 is a diagram for describing an exemplary data structure of the topic-distribution table 900. The topic-distribution table 900 includes a topic ID column 910 and a generation ratio column 920. In the topic ID column 910, information (topic ID) for identifying a topic uniquely is stored in the second exemplary embodiment. In the generation ratio column 920, a normalized generation ratio for the topic is stored.

In step S816, the subtopic extracting module 775 extracts a subtopic. The subtopic extracting module 775 extracts a subtopic for the target. Specifically, for example, a topic having the largest ratio is extracted from the document topics. In the example illustrated in FIG. 9, Topic 3 which is represented by T3 and which has a value of 22.6% is extracted.

In step S818, the context information determining module 780 determines context words. Similarly to step S514 in the flowchart illustrated in the example in FIG. 5, the context information determining module 780 determines a word whose highest probability value is one for the subtopic, to be a context word. In the example illustrated in FIG. 6, words “ [symbol] ” (words with a double underline in FIG. 6) which mean “already/in short supply/in stock” are determined to be context words for the subtopic. Alternatively, instead of use of the highest probability value, a word having a probability value equal to or larger than a predetermined threshold may be determined to be a context word.

In step S820, the context information output module 190 outputs the context information. In the above-described example, the words “ [symbol] ” are output as context words for the subtopic. Further, the context words for the main topic may be also output.

The following subtopic extraction method may be employed for the process in step S816. A subtopic (surrounding topic) which is likely to surround the target may be extracted by using Expression (1) described below.

$${argmax}_{topic} score ( topic ) = \frac{{\sum }_{{w}_{t} ∈ {W}_{t}} {\sum }_{{w}_{s} ∈ Surr ( {w}_{t} )} P ( {w}_{s} , topic )}{N} \\ \begin{matrix}{W}_{t} \text{:} words in a document which match the target \\ Surr ( {w}_{t} ) \text{:} words surrounding {w}_{t} \\ P ( {w}_{s} , topic ) \text{:} probability of topic for {w}_{s} \\ N \text{:} the total of words {w}_{s} \end{matrix} \qquad Expression ( 1 )$$

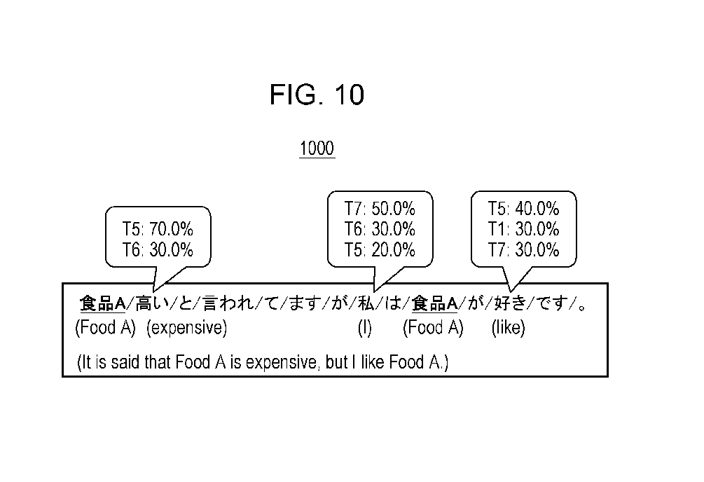

FIG. 10 is a diagram for describing an exemplary process according to the second exemplary embodiment. In FIG. 10, T means a topic, and, for example, T1 represents Topic 1. A word extraction result 1000 shows “ [symbol] [symbol] [symbol] ” which means “It is said that Food A is expensive, but I like Food A.” As a result of the process performed by the word topic estimating module 160, distributions are estimated as follows: “70.0% for Topic 5 and 30.0% for Topic 6” for “ [symbol] ” (“expensive”); “50.0% for Topic 7, 30.0% for Topic 6, and 20.0% for Topic 5” for “ [symbol] ” (“I”); and “40.0% for Topic 5, 30.0% for Topic 1, and 30.0% for Topic 7” for “ [symbol] ” (“like”).

In this example, T5 is a topic having the highest score because score (T5)=(0.7+0.2+0.4)/3=0.433 by using Expression (1). Therefore, T5 is regarded as a subtopic.

### Third Exemplary Embodiment

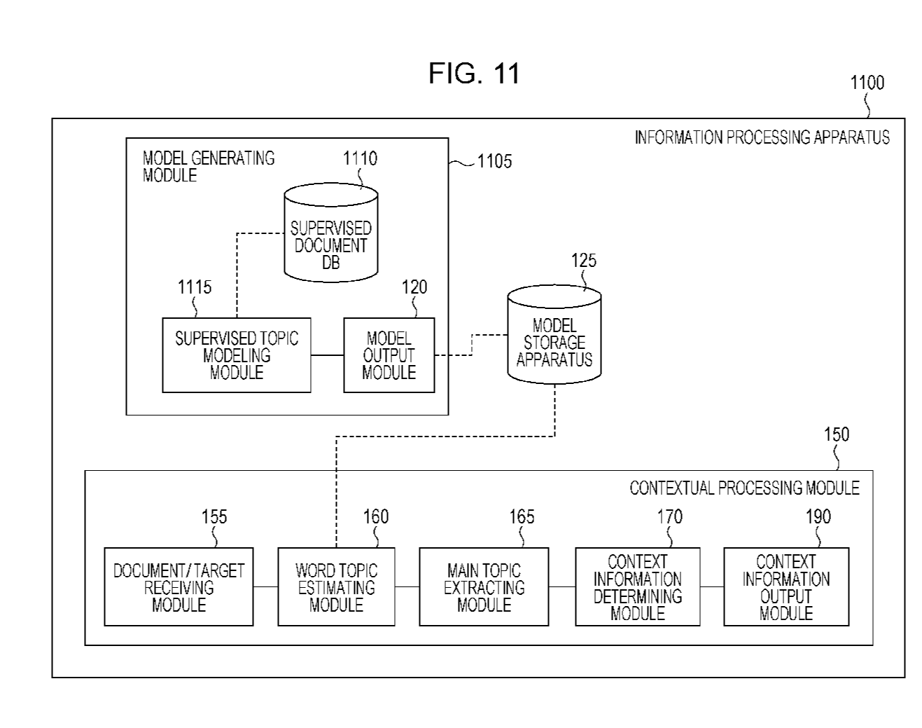

FIG. 11 is a conceptual diagram illustrating an exemplary module configuration according to a third exemplary embodiment. The third exemplary embodiment is one obtained by substituting a model generating module 1105 for the model generating module 105 of the information processing apparatus 100 according to the first exemplary embodiment. By using a supervised document DB 1110 and a supervised topic modeling module 1115, a topic model having a quality higher than that obtained when the model generating module 105 is used may be constructed.

An information processing apparatus 1100 includes the model generating module 1105, the model storage apparatus 125, and the contextual processing module 150. The model generating module 1105 includes the supervised document DB 1110, the supervised topic modeling module 1115, and the model output module 120.

The supervised document DB 1110 is connected to the supervised topic modeling module 1115. The supervised document DB 1110 is used to store multiple texts which serve as supervised data and which are collected in advance.

The supervised topic modeling module 1115 is connected to the supervised document DB 1110 and the model output module 120. From the multiple texts in the supervised document DB 1110, the supervised topic modeling module 1115 extracts words constituting the texts. The supervised topic modeling module 1115 applies a topic modeling technique to the extracted words, and generates a topic model. The multiple texts which are stored in the supervised document DB 1110 and which serve as supervised data are used as texts for machine learning, and a supervised topic modeling technique is applied as the topic modeling technique.

The model output module 120 is connected to the supervised topic modeling module 1115 and the model storage apparatus 125. The model output module 120 stores the topic model generated by the supervised topic modeling module 1115 in the model storage apparatus 125.

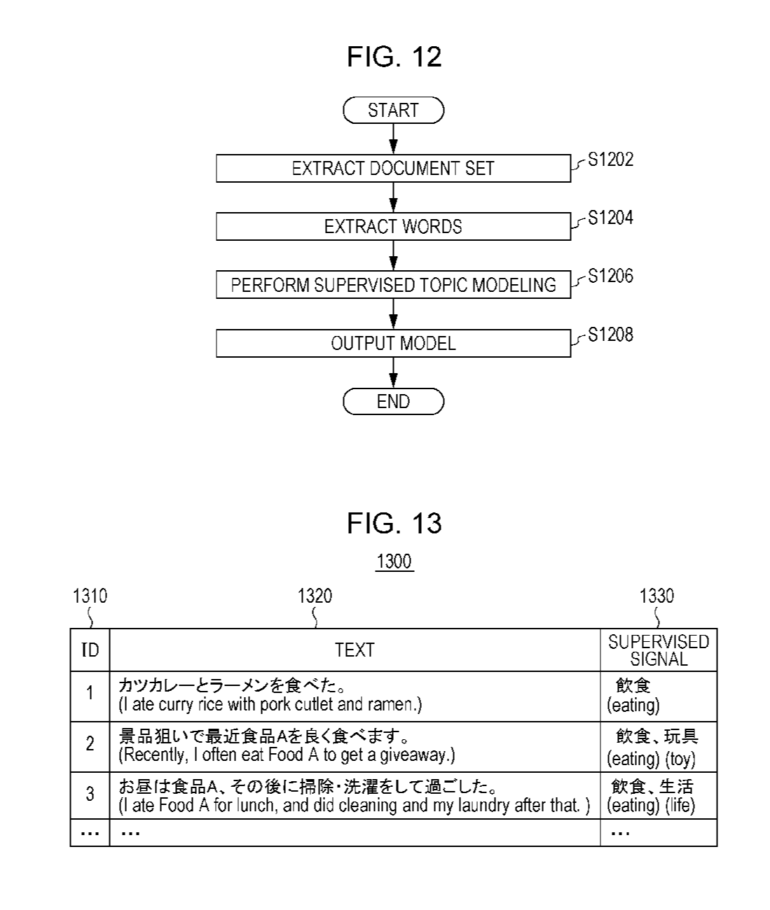

FIG. 12 is a flowchart of an exemplary process performed in the third exemplary embodiment (by the model generating module 1105). The processes in steps S1202 and S1204 are equivalent to those in steps S302 and S304 in the flowchart illustrated in the example in FIG. 3.

In step S1202, the supervised topic modeling module 1115 extracts a document set.

In step S1204, the supervised topic modeling module 1115 extracts words.

In step S1206, the supervised topic modeling module 1115 performs supervised topic modeling. That is, the supervised topic modeling module 1115 applies the supervised topic modeling technique to the word set in each text in the supervised document DB 1110. For example, labeled latent Dirichlet allocation (LLDA) is used as a specific method. An example of the supervised document DB 1110 is illustrated in FIG. 13. FIG. 13 is a diagram for describing an exemplary data structure of a document table 1300. The document table 1300 includes an ID column 1310, a text column 1320, and a supervised signal column 1330.

In the ID column 1310, information (ID) for identifying a text in the text column 1320 uniquely is stored in the third exemplary embodiment. In the text column 1320, a text is stored. In the supervised signal column 1330, one or more supervised signals for the text are stored. For example, by using a word “ [symbol] ” (“eating”) as a supervised signal, a text “ [symbol] [symbol] ” which means “I ate curry rice with pork cutlet and ramen.” is subjected to machine learning. By using words “ [symbol] ” (“eating”) and “ [symbol] ” (“toy”) as supervised signals, a text “ [symbol] [symbol] ” which means “Recently, I often eat Food A to get a giveaway.” is subjected to machine learning.

In step S1208, the model output module 120 outputs the topic model generated in step S1206, to the model storage apparatus 125.

### Fourth Exemplary Embodiment

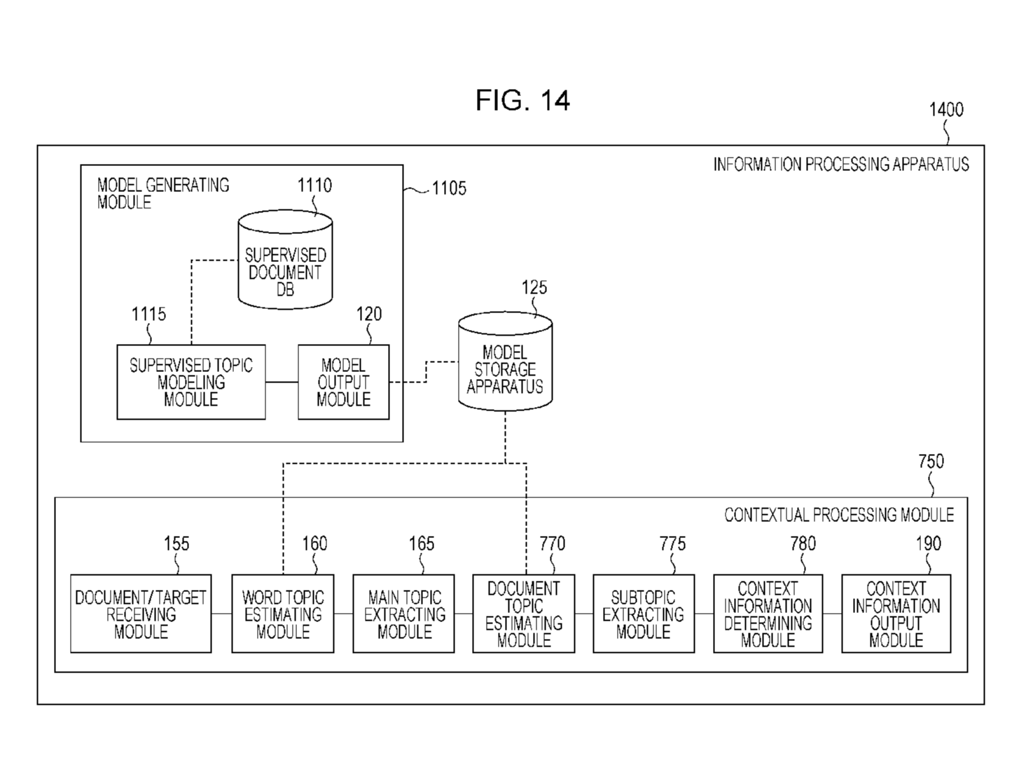

FIG. 14 is a conceptual diagram illustrating an exemplary module configuration according to a fourth exemplary embodiment. The fourth exemplary embodiment is one obtained by combining the contextual processing module 750 according to the second exemplary embodiment and the model generating module 1105 according to the third exemplary embodiment. By using of the supervised document DB 1110 and the supervised topic modeling module 1115, a topic model having a quality higher than that obtained when the model generating module 105 is used is constructed. By using the topic model to extract a subtopic for a target, context information for the target which covers a range wider than that in the first exemplary embodiment is obtained.

An information processing apparatus 1400 includes the model generating module 1105, the model storage apparatus 125, and the contextual processing module 750.

The model generating module 1105 includes the supervised document DB 1110, the supervised topic modeling module 1115, and the model output module 120. The supervised document DB 1110 is connected to the supervised topic modeling module 1115. The supervised topic modeling module 1115 is connected to the supervised document DB 1110 and the model output module 120. The model output module 120 is connected to the supervised topic modeling module 1115 and the model storage apparatus 125.

The model storage apparatus 125 is connected to the model output module 120, the word topic estimating module 160, and the document topic estimating module 770.

The contextual processing module 750 includes the document/target receiving module 155, the word topic estimating module 160, the main topic extracting module 165, the document topic estimating module 770, the subtopic extracting module 775, the context information determining module 780, and the context information output module 190.

The document/target receiving module 155 is connected to the word topic estimating module 160. The word topic estimating module 160 is connected to the model storage apparatus 125, the document/target receiving module 155, and the main topic extracting module 165. The main topic extracting module 165 is connected to the word topic estimating module 160 and the document topic estimating module 770. The document topic estimating module 770 is connected to the model storage apparatus 125, the main topic extracting module 165, and the subtopic extracting module 775. The subtopic extracting module 775 is connected to the document topic estimating module 770 and the context information determining module 780. The context information determining module 780 is connected to the subtopic extracting module 775 and the context information output module 190. The context information output module 190 is connected to the context information determining module 780.

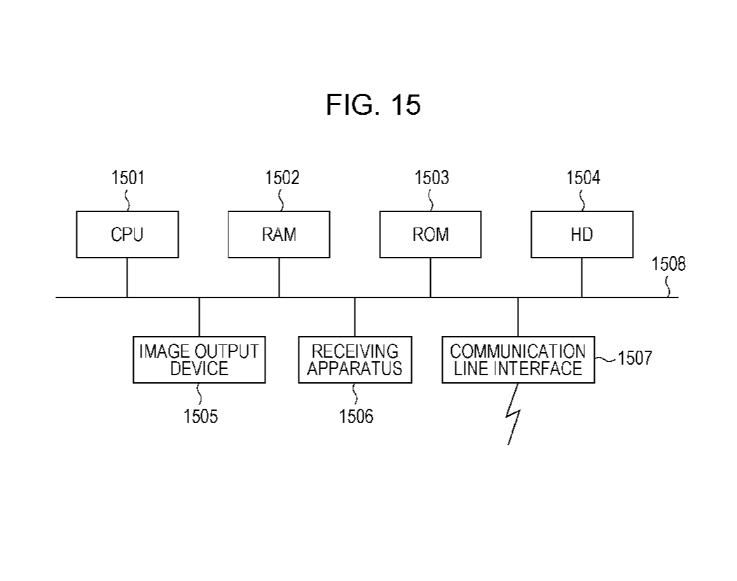

As illustrated in FIG. 15, the hardware configuration of a computer in which programs achieving the exemplary embodiments are executed constitutes a typical computer, and specifically, constitutes a computer or the like which may serve as a personal computer or a server. That is, for example, the configuration employs a CPU 1501 as a processor (arithmetic logical unit), and employs a RAM 1502, a read-only memory (ROM) 1503, and an HD 1504 as storage devices. For example, a hard disk or a solid state drive (SSD) may be used as the HD 1504. The computer includes the following components: the CPU 1501 which executes programs for the topic modeling module 115, the model output module 120, the document/target receiving module 155, the word topic estimating module 160, the main topic extracting module 165, the context information determining module 170, the context information output module 190, the document topic estimating module 770, the subtopic extracting module 775, the context information determining module 780, the supervised topic modeling module 1115, and the like; the RAM 1502 which is used to store the programs and data; the ROM 1503 which is used to store programs and the like for starting the computer; the HD 1504 which is an auxiliary memory (which may be a flash memory or the like) which serves as the document DB 110, the supervised document DB 1110, and the model storage apparatus 125; a receiving apparatus 1506 which accepts data on the basis of an operation performed by a user on a keyboard, a mouse, a touch panel, or the like; an image output device 1505, such as a cathode-ray tube (CRT) or a liquid crystal display; a communication line interface 1507 for establishing connection to a communication network, such as a network interface card; and a bus 1508 for connecting the above-described components to each other and for receiving/transmitting data. Computers having this configuration may be connected to one another via a network.

For an exemplary embodiment achieved by using computer programs among the above-described exemplary embodiments, the computer programs which are software are read into a system having the hardware configuration, and the software and the hardware resources cooperate with each other to achieve the above-described exemplary embodiment.

The hardware configuration in FIG. 15 is merely one exemplary configuration. The exemplary embodiments are not limited to the configuration in FIG. 15, and may have any configuration as long as the modules described in the exemplary embodiments may be executed. For example, some modules may be constituted by dedicated hardware, such as an application specific integrated circuit (ASIC), and some modules which are installed in an external system may be connected through a communication line. In addition, systems having the configuration illustrated in FIG. 15 may be connected to one another through communication lines and may cooperate with one another. In particular, the hardware configuration may be installed in portable information communication equipment (including a portable phone, a smartphone, a mobile device, a wearable computer), home information equipment, a robot, a copier, a fax, a scanner, a printer, a multi-function device (image processing device having two or more functions of scanning, printing, copying, faxing, and the like), or the like as well as a personal computer.

The programs described above may be provided through a recording medium which stores the programs, or may be provided through a communication unit. In these cases, for example, the programs described above may be interpreted as an invention of “a computer-readable recording medium that stores a program”.

The term “a computer-readable recording medium that stores a program” refers to a computer-readable recording medium that stores programs and that is used for, for example, the installation and execution of the programs and the distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray® Disk, a magneto-optical disk (MO), a flexible disk (FD), a magnetic tape, a hard disk, a ROM, an electrically erasable programmable ROM (EEPROM®), a flash memory, a RAM, and a secure digital (SD) memory card.

The above-described programs or some of them may be stored and distributed by recording them on the recording medium. In addition, the programs may be transmitted through communication, for example, by using a transmission medium of, for example, a wired network which is used for a local area network (LAN), a metropolitan area network (MAN), a wide area network (WAN), the Internet, an intranet, an extranet, and the like, a wireless communication network, or a combination of these. Instead, the programs may be carried on carrier waves.

The above-described programs may be included in other programs, or may be recorded on a recording medium along with other programs. Instead, the programs may be recorded on multiple recording media by dividing the programs. The programs may be recorded in any format, such as compression or encryption, as long as it is possible to restore the programs.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first extracting unit that applies a topic model to target text information and that extracts topic distributions for words constituting the text information;
a second extracting unit that extracts a first topic for the text information from the topic distributions extracted by the first extracting unit; and
a third extracting unit that extracts a word satisfying a predetermined condition, from at least one word having the first topic, as a context word in the text information, the first topic being extracted by the second extracting unit.

2. The information processing apparatus according to claim 1, further comprising:
a fifth extracting unit that applies a topic modeling technique to the target text information and that extracts topic distributions in the text information;
a sixth extracting unit that extracts a second topic for the text information from the topic distributions extracted by the fifth extracting unit; and
a seventh extracting unit that extracts a word satisfying a predetermined condition, from at least one word having the second topic, as a context word in the text information, the second topic being extracted by the sixth extracting unit.

3. The information processing apparatus according to claim 1, further comprising:
a fourth extracting unit that extracts, from pieces of text information, words constituting the text information; and
a generating unit that applies a topic modeling technique to the words extracted by the fourth extracting unit and that generates the topic model.

4. The information processing apparatus according to claim 2, further comprising:
a fourth extracting unit that extracts, from pieces of text information, words constituting the text information; and
a generating unit that applies a topic modeling technique to the words extracted by the fourth extracting unit and that generates the topic model.

5. The information processing apparatus according to claim 3,
wherein the generating unit uses, as the pieces of text information, pieces of text information serving as supervised data, and applies a supervised topic modeling technique as the topic modeling technique.

6. The information processing apparatus according to claim 4,
wherein the generating unit uses, as the pieces of text information, pieces of text information serving as supervised data, and applies a supervised topic modeling technique as the topic modeling technique.

7. A non-transitory computer readable medium storing a program causing a computer to execute a process comprising:
applying a topic model to target text information and extracting topic distributions for words constituting the text information;
extracting a first topic for the text information from the extracted topic distributions; and
extracting a word satisfying a predetermined condition, from at least one word having the first topic, as a context word in the text information.

8. An information processing method comprising:
applying a topic model to target text information and extracting topic distributions for words constituting the text information;
extracting a first topic for the text information from the extracted topic distributions; and
extracting a word satisfying a predetermined condition, from at least one word having the first topic, as a context word in the text information.
